(19) United States
(12) Patent Application Publication
(10) Pub. No.: US 2009/0090042 A1
(43) Pub. Date: Apr. 9, 2009

(54) DEVICE FOR TRAPPIING A MOLE

(75) Inventors: Romain Lasseur, Bully (FR); Bruno Mathieu, Aiguilhe (FR)

Correspondence Address: YOUNG & THOMPSON, 209 Madison Street, Suite 500, ALEXANDRIA, VA, 22314, US

(73) Assignees: DE SANGOSSE, Pont Du Casse (FR); SIPLAST, Saint Germain Laprade (FR)

(21) Appl. No.: 11/940,335

(22) Filed: Nov. 15, 2007

(30) Foreign Application Priority Data
Oct. 5, 2007 (FR) 07 58088

(51) Int. Cl. A01M 23/08; A01M 23/00

(52) U.S. Cl. 43/65; 43/85; 43/77

(57) ABSTRACT

The object of the invention is a device for trapping a mole, in particular for the purpose of its eradication, forming a passage (10) through which the mole can travel and comprising a support (12) and means (14) for immobilizing said mole.

This invention relates to a device for trapping a mole, in particular for the purpose of its eradication.

The mole is present in most of the temperate zones inhabited by man.

It is a solitary animal that lives primarily in the tunnels that it digs and where it traps its food, consisting of various animals of the subsoil: earthworms, larvae and insects, slugs, . . . .

The network of tunnels where the mole lives is complex; it can comprise deep tunnels with 15 to 25 cm of surface area and more superficial tunnels that are the hunting tunnels.

Because of the mounds, also called molehills, that the mole creates to evacuate the earth from its tunnels, it is considered to be the enemy of gardeners and farmers, but also of the private individuals who put a lot of effort into maintaining their lawns. Although it is small in size and weighs only about one hundred grams, the mole(s) sometimes cause(s) damage whose importance, generally assessed by the number of molehills, asks for the intervention of a professional, the mole catcher, to implement an eradication of the animal or animals.

Although the mole watches, it is, however, unable to distinguish a moving animal and therefore avoids returning to the surface where it is very vulnerable. By contrast, the mole hears perfectly, has a strong sense of smell, making it possible to mark a night crawler at several centimeters in its tunnel or close to it in the subsoil, as well as a strongly developed tactile sense owing to tactile hairs, whiskers, that are present on its muzzle.

These very developed senses allow a mole to detect possible dangers and to protect itself from predators that cannot follow it into its tunnels.

This is also why, when a man wants to destroy a mole directly by uprooting it with the aid of a spade or a shovel, he should summon up his patience and remain very inconspicuous if he wants to have a chance of locating and uprooting this little animal that can move 3 to 4 km/hour in its tunnels.

Whereby this uprooting method quite often has proven unsuccessful, various types of traps and products have been developed to eliminate this little animal.

In general, there are 2 to 6 tunnels exiting from a molehill, and the mole therefore always comes from a tunnel to the molehill. By placing the traps at each tunnel inlet of a molehill that is regularly used, the animal cannot avoid passing into a trap.

Certain traps of the prior art use an explosive charge with an electronic trigger or elements with mechanical armament for killing the mole owing to the explosion or to the violence of the blast borne by said element. An accidental triggering of the explosion or of the mechanical armament is likely to injure the first user, i.e., the individual that is responsible for the placement of said trap, or possibly to injure the second user: i.e., any individual, in particular children, that are present on the installation site of said trap. These risks are not acceptable, and the use of said traps by private individuals is not recommended.

Other eradication methods of the prior art use poisons or repellents placed directly in the tunnels or via food items of the mole, such as earthworms and other worms. These methods have uncertain, and even relatively limited, results, because they are not selective, and their effectiveness cannot really be known. In the case of a poison being used, there is no guarantee that only the mole has found the poison and that it is only the mole that will eat it and then die from it. In the case of repellent, nothing ensures that the mole definitively left the location and that it will not return at the end of a certain period.

Finally, some devices of the prior art have a half-closed chamber with trapdoors or means of closing said chamber that reclose after the animal passes through in order to capture it. These capturing devices are relatively bulky and costly, which prevents the user from using them at each tunnel inlet of a molehill, and, in addition, they require a precise placement so as to avoid keeping the mole away.

This invention has as its object to avoid the drawbacks of the traps and methods for eradicating moles of the prior art by proposing a device for trapping moles that does not exhibit any danger for the first user as for the second user, starting from the placement of the device until its withdrawal from the tunnel.

In addition, the device according to the invention is easy to use, and economical, and its effectiveness can be verified because it allows the eradication of the mole or moles present in a garden, in crop fields, or on a lawn.

The inventor carefully noted that a mole that is immobilized for a certain time dies due to stress or lack of food, whereby a mole eats the equivalent of its own weight within 24 hours.

Consequently, in particular for the purpose of its eradication, the invention proposes a device for trapping a mole, in particular for the purpose of its eradication, forming a passage 10 that can be traversed by the mole and that comprises a support 12 and means 14 for immobilizing said mole.

Other characteristics and advantages will emerge from the following description of the invention, a description that is provided only by way of example, opposite the accompanying drawings in which:

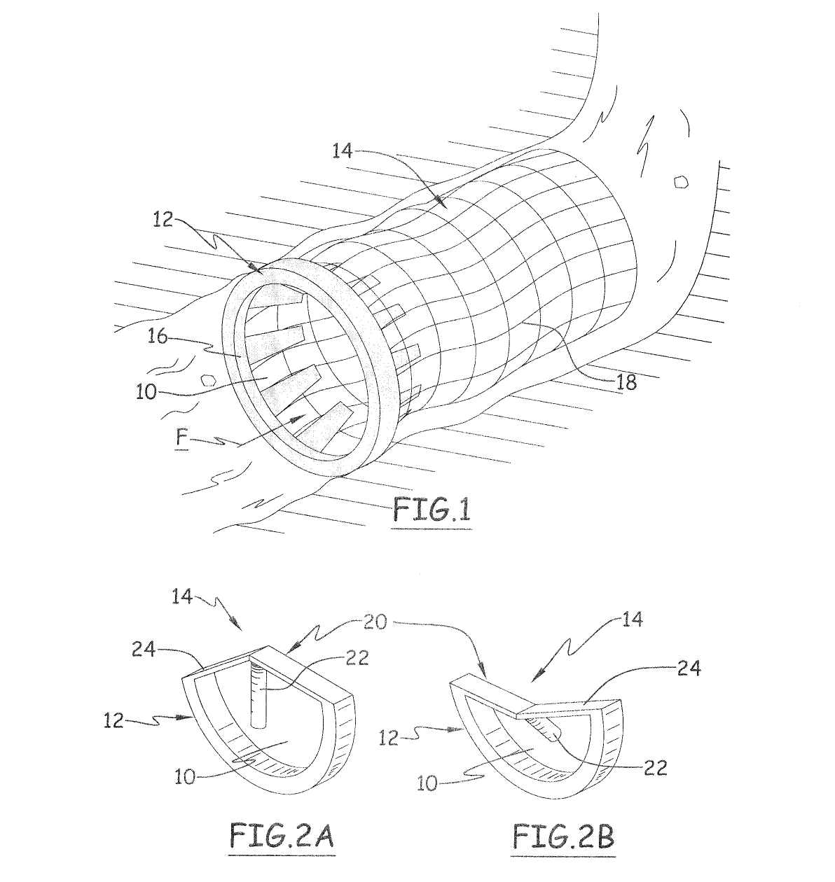

FIG. 1 shows a device for trapping a mole according to a first embodiment of the immobilization means of the invention,

FIGS. 2A and 2B show a device for trapping a mole according to a first embodiment of a moving part in a second embodiment of the immobilization means of the invention, respectively in a first position for allowing a mole to pass and a second position for blocking him,

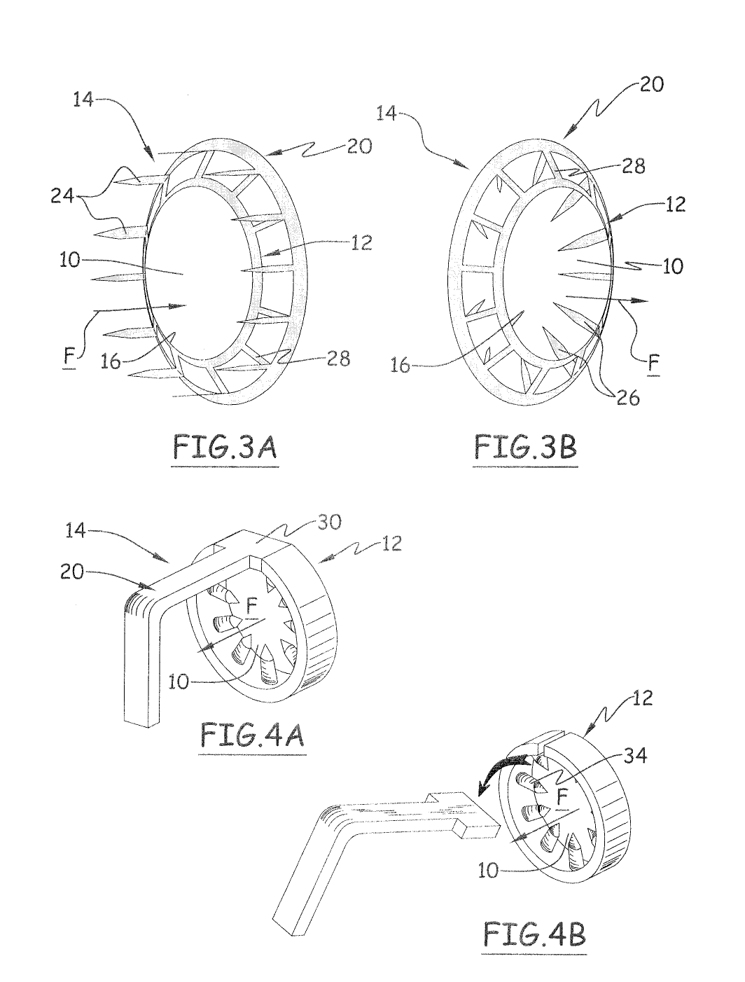

FIGS. 3A and 3B show a device for trapping a mole according to a second embodiment of a moving part in a second embodiment of means for immobilization of the invention, respectively in a first position for allowing a mole to pass and a second position for blocking him,

FIGS. 4A and 4B show a device for trapping a mole according to a third embodiment of a moving part in a second embodiment of immobilization means of the invention, respectively in a first position for allowing a mole to pass and a second position for blocking him;

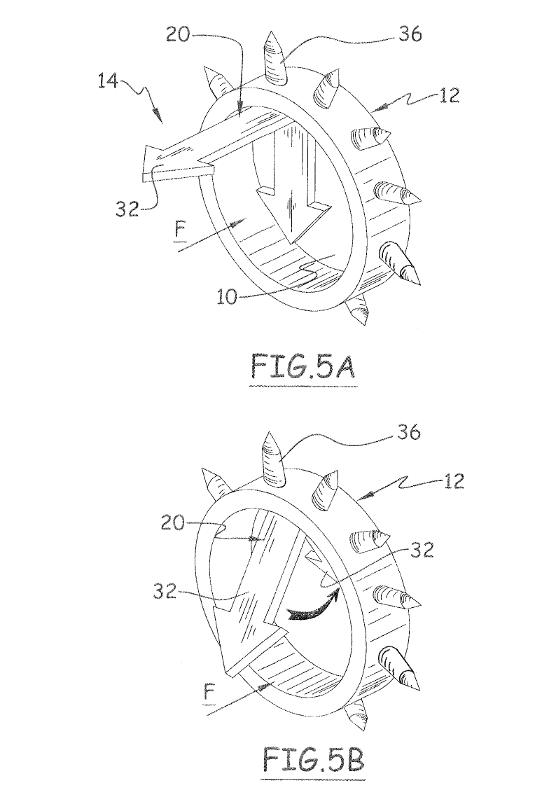

FIGS. 5A and 5B show a device for trapping a mole according to a fourth embodiment of a moving part in a second embodiment of the immobilization means of the invention, respectively in a first position for allowing a mole to pass and a second position for blocking him.

As shown in FIG. 1, a device for trapping a mole according to the invention is provided to be placed in at least one tunnel or a tunnel inlet located at a molehill.

Whereby said trapping device is placed at a tunnel, it is therefore completely concealed in the soil and does not have any dangerous part projecting beyond the soil.

The trapping device forms a passage 10 that can be traversed by the mole and comprises a support 12 with a suitable shape to be used in a tunnel.

Preferably, the profile of the outside periphery of the support 12 is approximately circular, and the production material of said support 12 is slightly deformable so that the user can easily position it in a mole tunnel.

So as to be able to immobilize a mole during his passage into one of his tunnels, the device according to the invention forms a passage 10 that can be traversed by the mole and comprises immobilization means 14 that can block the mole during his passage.

A passage that can be traversed is defined by the invention as a trapping device that is to represent a minimum obstacle to the passage of the mole so as not to drive said mole off or make him suspicious.

For this purpose, an outlet hole 16 that corresponds to the passage 10 through which the mole can travel is made in said support 10, whereby said outlet hole 16 is essentially larger than the body of a mole.

Preferably, a support 12 does not exceed approximately ten millimeters in length and several millimeters of thickness between its outside periphery and the outlet hole 16.

Said support 12 is advantageously made of plastic.

So as to make it possible to eradicate the animal, the trapping device according to the invention comprises immobilization means 14 that will keep the animal blocked at the same location, preventing it from eating and/or causing such stress in it that its death ensues within several hours, from 3 to 30 hours to provide a connection.

According to a first embodiment of the immobilization means 14, illustrated in FIG. 1, said immobilization means 14 comprise a net 18 that is connected to support 12 and that comprises at least one layer of flexible threads that are interlaced so as to snare the mole in said net 18.

A net 18 forms a casing between the mole and the tunnel with a length that is approximately greater than the mean length of a mole, so that the animal cannot find support directly on the wall of said tunnel,

Said net 18 can come either in the form of a chute that does not have a bottom, whereby said chute can be made simply by winding a piece of thread on itself, or said net 18 can be closed at the end like a hoop net.

Preferably, a net 18 comprises several layers of flexible threads, whereby said flexible threads are made of nylon, for example, and interlaced along a mesh of between 5 and 20 millimeters.

Thus, once the mole has gone beyond the support 12 in the direction that is indicated by the arrow F in FIG. 1, it is completely enveloped in the net 18 of immobilization means 14 and begins to struggle to try to extricate itself. The more it struggles and tries to grip through the meshes of said net 18, the more its front and rear members are ensnared in the interlaced threads of the net 18, causing its definitive immobilization.

According to a second embodiment of the immobilization means 14 of the invention, said immobilization means 14 comprise a moving part 20 for passing at least a portion of the mole's body and of which said putting into motion directly brings about the reduction of the traversable passage 10 that is formed by the support 12 and/or the immobilization means 14 around the body of said mole.

This simplicity of the trapping device is an assessment of the reliability and effectiveness of the eradication of one or more moles that can be conducted with a device according to the invention.

According to a first embodiment, illustrated in FIGS. 2A and 2B, the moving part 20 in the passage of at least one portion of a mole that comprises at least one lug 22 that is connected to a deformable portion 24 of said support 12 is deforming toward the inside of the traversable passage 10

More specifically, the lug 22 is found crosswise to the passage 10, and the deformable portion 24 of the support 12 comprises at least three folds that allow it to fold toward the inside of said passage 10. When the mole pushes the lug 22, it is wedged by the fold of the deformable portion 24 toward the inside of the passage 10 where it is found.

According to a second embodiment, illustrated in FIGS. 3A and 3B, the moving part 20 in the passage of at least a portion of a mole comprises several points 26 that are connected to a deformable portion 28 of said support 12 that makes it possible to orient said points 26 toward the inside of the traversable passage 10.

Before the mole passes in the direction that is illustrated by the arrow F, the deformable portion 28 of the support 12 makes it possible to place the outlet hole 16 upstream from the support portion 12, resting on the tunnel wall, and to affix the points 26 to the tunnel wall. Then, the passage of at least a portion of the mole's body causes a downstream shift of the outlet hole 16, which brings about a movement of the deformable portion 28 that makes it possible to orient the points 26 toward the inside of the traversable passage 10 to grip the mole and to immobilize it.

According to a third embodiment, illustrated in FIGS. 4A and 4B, the moving part 20 in the passage of at least one portion of the mole comprises at least one shim 30 that is clamped by a support 12 that can take a first position for allowing a mole to pass in the presence of said shim 30 and a second position for blocking the mole in the absence of said shim 30.

In this embodiment, the support 12 is slit over its length, and the shim 30 has suitable dimensions for being clamped between the two ends of the support 12 that are present on both sides of the slit. The material of the support 12 has elastic characteristics that allow the ends of the support 12 to be separated by the shim 30 to open the traversable passage 10, and, conversely, to come together so that the support 12 closes on the mole to immobilize it when the shim 30 has been withdrawn. Said shim 30 comprises a portion, preferably an arm, located in the traversable passage 10 so that the passage of at least a portion of the mole's body causes said shim 30 to be moved and then dislodged from the slot of the support 12.

According to a fourth embodiment, illustrated in FIGS. 5A and 5B, the moving part 20 in the passage of at least one portion of a mole comprises at least one bracket 32 that comprises at least two arms and that can pivot relative to the support 12 from a first position for allowing a mole to pass toward a second position for blocking a mole.

Preferably, the two arms of the bracket 32 are essentially perpendicular. In this manner, in the passage position, a first arm is horizontal, essentially flattened against the tunnel wall, while the second arm is essentially vertical, located in the traversable passage 10. The mole thus passes under the first essentially horizontal arm, then it pushes the second arm essentially vertically causing the movement of the first arm into the traversable passage 10. The mole is immobilized when the two arms of the bracket 32 are in blocking position, i.e., both in the traversable passage 10. Each arm of the bracket 32 can have a pointed end, as illustrated in FIGS. 5A and 5B, so as to be driven into the mole's body to prevent him from freeing himself.

More particularly, in the case of the third embodiment of the moving part 20 that comprises a shim 30, but also optionally in its other embodiments, a support 12 can comprise at least one internal pin 34 that is located in the outlet hole 16 of a support 12, whereby said internal pin 34 is oriented toward the inside of the traversable passage 10 so as to improve the immobilization of a mole during the reduction of the traversable passage 10 that is produced by putting the moving part 20 into motion.

For all the different embodiments of the device for trapping a mole and as illustrated in FIGS. 54A and 5B, the support 12 can comprise at least one external pin 36 that is oriented toward the outside of the traversable passage 10. In this way, during the placement of said trapping device, said external pin 36 is planted in the tunnel wall, thus preventing a mole that is blocked by immobilization means 14 from being able to get away with the trapping device around it.

The invention also provides connecting the trapping device to the surface of the ground by a small chain and a stake so as to be able to verify the possible capture of a mole and to carry out the withdrawal of the device from the tunnel.

So as to adapt to various tunnel diameters or to the immobilization of other animals circulating in tunnels, said trapping device according to the invention can be adaptable or comprise adaptation means. Any application and adaptation of the trapping device according to the invention with the immobilization or the capture of other animals is, of course, covered by the invention, just as the variant embodiments can be imagined from this description.

1. Device for trapping a mole, in particular for the purpose of its eradication, forming a passage (10) that can be traversed by the mole and comprising a support (12) and means (14) for immobilizing said mole.

2. Device for trapping a mole, in particular for the purpose of its eradication, according to claim 1, characterized in that the immobilization means (14) comprise a net (18) that is connected to the support (12) and that comprise at least one layer of flexible threads that are interlaced so as to snare the mole in said net (18).

3. Device for trapping a mole, in particular for the purpose of its eradication, according to claim 1, wherein the immobilization means (14) comprise a moving part (20) in the passage of at least a portion of the mole's body and whose said putting into motion directly drives the reduction of the traversable passage (10) that is formed by the support (12) and/or the immobilization means (14) around the body of said mole.

4. Device for trapping a mole, in particular for the purpose of its eradication, according to claim 3, wherein the moving part (20) comprises at least one lug (22) that is connected to a deformable part (24) of said support (12) being deformed toward the inside of the traversable passage (10).

5. Device for trapping a mole, in particular for the purpose of its eradication, according to claim 3, wherein the moving part (20) comprises several points (26) that are connected to a deformable portion (28) of said support (12) that makes it possible to orient said points (26) toward the inside of the traversable passage (10).

6. Device for trapping a mole, in particular for the purpose of its eradication, according to claim 3, wherein the moving part (20) comprises at least one shim (30) that is clamped by a support (12) that can take a first position for allowing a mole to pass in the presence of said shim (30) and a second position for blocking the mole in the absence of said shim (30).

7. Device for trapping a mole, in particular for the purpose of its eradication, according to claim 3, wherein the moving part (20) comprises at least one bracket (32) that comprises at least two arms and that can pivot relative to the support (12) from a first position for allowing a mole to pass toward a second position for blocking the mole.

8. Device for trapping a mole, in particular for the purpose of its eradication, according to claim 1, wherein the support (12) comprises at least one internal pin (34) that is oriented toward the inside of the traversable passage (10).

9. Device for trapping a mole, in particular for the purpose of its eradication, according to claim 1, wherein the support (12) comprises at least one external pin (36) that is oriented toward the outside of the traversable passage (10).
